(19) United States
(12) Patent Application Publication
(10) Pub. No.: US 2003/0024752 A1
(43) Pub. Date: Feb. 6, 2003

(54) Wheelie scooter

(76) Inventors: Richard A. Mayer, Saugus, CA (US); Devin Stewart Bank, Los Angles, CA (US)

Correspondence Address: Jack C. Munro, Suite 225, 28720 Roadside Drive, Agoura Hills, CA, 91301, US

(21) Appl. No.: 09/921,345

(22) Filed: Aug. 3, 2001

(51) Int. Cl. B62D 61/02

(52) U.S. Cl. 180/220; 280/755

(57) ABSTRACT

A wheelie scooter which utilizes an auxiliary wheel assembly mounted aft of the rear wheel of the scooter with the rear wheel in a first position. The auxiliary wheel assembly is adjustable to vary the distance of the auxiliary wheel of the auxiliary wheel assembly from the surface on which the scooter is being operated to thereby provide different levels of skill to riders of the scooter when performing of a stunt maneuver known as a wheelie. The rear wheel of the scooter can be adjusted to a second position where the scooter operates as a normal scooter and not as a wheelie scooter.

### BACKGROUND OF THE INVENTION

1. Field of the Invention

This invention relates to a scooter and more particularly to a scooter that has been designed to include an auxiliary wheel assembly which can be usable by a rider in performing of a stunt maneuver which is known as a wheelie.

2. Description of the Related Art

In the past, there has been a stunt maneuver that is known as a wheelie utilized in conjunction with bicycles, motorcycles, tricycles and scooters. A wheelie is defined as a stunt maneuver in which a front wheel of a two wheeled vehicle is raised off the surface on which the vehicle is located with the vehicle to be supported solely by the rear wheel as the vehicle continues to maneuver. Youthful riders of such vehicles commonly seek to emulate such a stunt. Such stunts are exceedingly common in conjunction with skateboards.

In recent years, there has been a new type of vehicle that is being marketed which is actually a new form of an old vehicle and is called a scooter. The present day scooters are exceedingly light weight, utilize exceedingly small wheels resembling skateboard wheels. Within the past few years, there has been developed a further progression of such a vehicle where the scooter is motorized. Youthful riders are starting to perform “wheelies” in conjunction with these motorized scooters. A problem encountered when youthful riders are attempting to perform a wheelie in conjunction with a motorized scooter is the youthful rider has a tendency to topple sideways or fall over backwards as a result of inexperience or lack of riding ability. Accordingly, it would be desirable to provide an auxiliary wheel assembly in conjunction with the scooter that provides an extra wheel to contact the surface with this extra wheel being located aft of the rear wheel of the scooter. The use of the auxiliary wheel assembly will function to prevent or at least minimize the possibility of over rotation or falling over sideways of the user and thus increase the safety and stability of the user in performing a wheelie.

A desirable type of auxiliary wheel assembly could be what is conventionally known as a skateboard truck. A skateboard truck takes the form of a pair of wheels with a mounting frame located between the wheels. This mounting frame is connected through a shock absorber assembly to a mounting bracket. The mounting bracket is typically mounted onto the body of a skateboard. By the user's shifting of one's weight when riding the skateboard, the mounting bracket can move relative to the mounting frame about the shock absorber. By the user shifting one's weight, the skateboard can be maneuvered to proceed in different directions. It has been found to be particularly desirable to use a skateboard truck as the auxiliary wheel assembly within the present invention.

In the past, scooters that have been designed to perform wheelies have a short wheel base and are inherently more difficult to operate because of this short wheel base than a conventional scooter. A conventional scooter has a longer wheel base. In the past, there have been conventional scooters designed that have the longer wheel base, and there have been wheelie scooters that have been designed that have a shorter wheel base. Prior to the present invention, it has not been known to design a scooter that can be positioned to be in a wheelies mode, and by a simple modification, place the scooter in a conventional operating mode.

### SUMMARY OF THE INVENTION

The basic embodiment of the present invention comprises a wheelie scooter which utilizes a planar platform mounted between a front wheel and a rear wheel. Connected to the front wheel is a steering post with a handlebar attached at the upper end of the steering post. A motor is connected to the rear wheel and by power supplied by a battery is to affect motor operation of the scooter. There is a platform extension that is connected to the main platform and extends outwardly of the rear wheel. A mounting base is mounted on the platform extension. This mounting base is inclined relative to the surface on which the scooter is being operated when both the front wheel and rear wheel are in contact with the surface. A mounting bracket of an auxiliary wheel assembly is fixedly mounted on the mounting base with this mounting bracket being adjustable to various positions with the auxiliary wheel assembly to be fixedly located in each of the positions. The auxiliary wheel assembly includes an auxiliary wheel which is spaced from the surface when both the front wheel and the rear wheel are resting on the surface. The auxiliary wheel assembly is then to be usable by the user in the performing of a wheelie.

A further embodiment of the present invention is where the basic invention is modified to where the motor is operated electrically.

A further embodiment of the present invention comprises where the basic embodiment is modified by the mounting base including a flat surface.

A still further embodiment of the present invention is where the basic embodiment is modified with the connection between the mounting bracket and mounting base being accomplished by a series of elongated slots with a separate fastener engaging with each elongated slot.

A further embodiment of the present invention is where the basic embodiment is modified by the auxiliary wheel being smaller than the rear wheel.

A further embodiment of the present invention is where the basic embodiment is modified by the forward edge of the mounting base being located closer to the surface on which the scooter is located than the rearward edge of the mounting base.

A further embodiment of the present invention is where the basic embodiment is modified by the rear wheel being adjustable between multiple positions so the scooter can operate as a normal scooter in one position and as a wheelie scooter in another position.

A further basic embodiment of the present invention comprises a scooter which utilizes the main platform mounted between a front wheel and a rear wheel. The rear wheel is adjustable between multiple positions and fixable to the main platform in each position permitting the scooter to operate as a normal scooter in one position and as a wheelie scooter in another position.

A further basic embodiment of the present invention is where there is a main platform mounted between a front wheel and a rear wheel. A motor and the rear wheel is mounted on a mounting plate. The mounting plate is mountable in two different positions (a first position and a second position) on the main platform with the first position locating the rear wheel between the motor and the front wheel and the second position locating the motor between the rear wheel and the front wheel. The first position permits the scooter to be operable to perform wheelies and the second position permits the scooter to operate as a normal scooter not able to perform wheelies.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a side elevational view of the wheelie scooter of the present invention depicting the position of the scooter in phantom when performing a wheelie;

FIG. 2 is a back view of the wheelie scooter of the present invention taken along line 2-2 of FIG. 1;

FIG. 3 is a side view of the rear wheel are of the wheelie scooter of the present invention taken along line 3-3 of FIG. 2;

FIG. 4 is a cross-sectional view showing the mounting arrangement of the auxiliary wheel assembly of the wheelie scooter of the present invention taken along line 4-4 of FIG. 2;

FIG. 5 is a top plan view of the mounting arrangement for the auxiliary wheel assembly of the wheelie scooter of the present invention taken along line 5-5 of FIG. 4;

FIG. 6 is a side elevational view of a modified rear wheel mounting structure of the scooter of the present invention showing the rear wheel in the position for the scooter to perform wheelies;

FIG. 7 is a bottom view taken along line 7-7 of FIG. 6;

FIG. 8 is a side elevational view of the modified rear wheel mounting structure of the scooter of the present invention showing the rear wheel in the position for conventional scooter operation with the scooter not intended to be used to perform wheelies; and

FIG. 9 is a bottom view taken along line 9-9 of FIG. 8.

### DETAILED DESCRIPTION OF THE INVENTION

The wheelie scooter of the present invention by the utilizing of a motor provides continuous operational power to the rear wheel of the wheelie scooter even when the scooter is in the position of performing a wheelie. By the utilizing of a single rear wheel, the wheelie scooter is able to achieve rapid pivoting or turning while even doing a wheelie.

Referring particularly to the drawings, there is shown a scooter 10 which has a main platform 12 that connects between a front wheel fork 14 and a rear wheel 16. Mounted on the front wheel 14 is a front wheel 18. The front wheel 18 and the rear wheel 16 are designed to roll on a surface 20. Steering tube 22 connects to the front wheel fork 14. At the upper free end of the steering tube 22 is a handlebar 24. Generally, both the front wheel 18 and the rear wheel 16 are of the same size although such is not mandatory.

Mounted in conjunction with the main platform 12 is a battery compartment 26 which is formed within a battery housing 28. Mounted within the battery compartment 26 is a battery 30. Integrally connected to the main platform 12 and extending rearwardly thereof is a platform extension 32. The platform extension 32 basically comprises a pair of frame members which are located in a bifurcated arrangement with the rear wheel 16 being mounted therebetween and rotatably mounted on the frame members. Platform extension 32 also includes a standing platform 34. The standing platform 34 is mounted between upstanding supports 36 which are integrally connected to the platform extension 32. The forward edge of the standing platform 34 is fixedly mounted onto the support surface 38 of the main platform 12. The user, when operating of the scooter 10, can either stand on the support surface 38 or the standing platform 34. The standing platform 34 includes a upwardly flared edge 40 located at the free edge of the standing platform 34. It is to be understood that the main platform 12, the platform extension 32 and the standing platform 34 will all be constructed of metallic material such as aluminum or steel.

Mounted between and to the bifurcated members of the platform extension 32 is a motor 42. The motor 42 is to be supplied electrical energy by the battery 30. The motor 42 causes rotation of the rear wheel 16 through a drive belt 44. It is to be understood that there will be mounted in conjunction with the handlebar 24 an appropriate speed control lever, which is not shown.

Mounted at the aft edge of the platform extension 32 and in between the bifurcated frame members of the platform extension 32 is a mounting base 46. The mounting base 46 is planar and is formed integral with the platform extension 32. It is to be noted that the mounting base 46 is located inclined to the surface 20 with a typical angle of inclination being about twelve degrees.

An auxiliary wheel assembly 48, which generally is in the form of a skateboard truck 50, is mounted on a mounting bracket 52. The skateboard truck 50 permits turning by the rider shifting his or her weight. The skateboard truck 50 also includes a shock absorber unit 54. The skateboard truck 50 has mounted thereon a pair of spaced apart wheels 56 and 58. The wheels 56 and 58 are of the same size and are noticed to be substantially smaller in size than the wheels 16 and 18. In order to achieve proper operation of the structure of the present invention, the wheels 56 and 58 will always be smaller than the wheels 16 and 18. The skateboard truck 50 could be mounted on a plate (not shown) which is mounted in a cantilevered manner on the mounting base 46. This would provide a torsion spring type of mounting with “give” to occur when pressure is applied against the skateboard truck 50 when performing a wheelie. This spring type of action would provide additional excitement to the rider when performing wheelies.

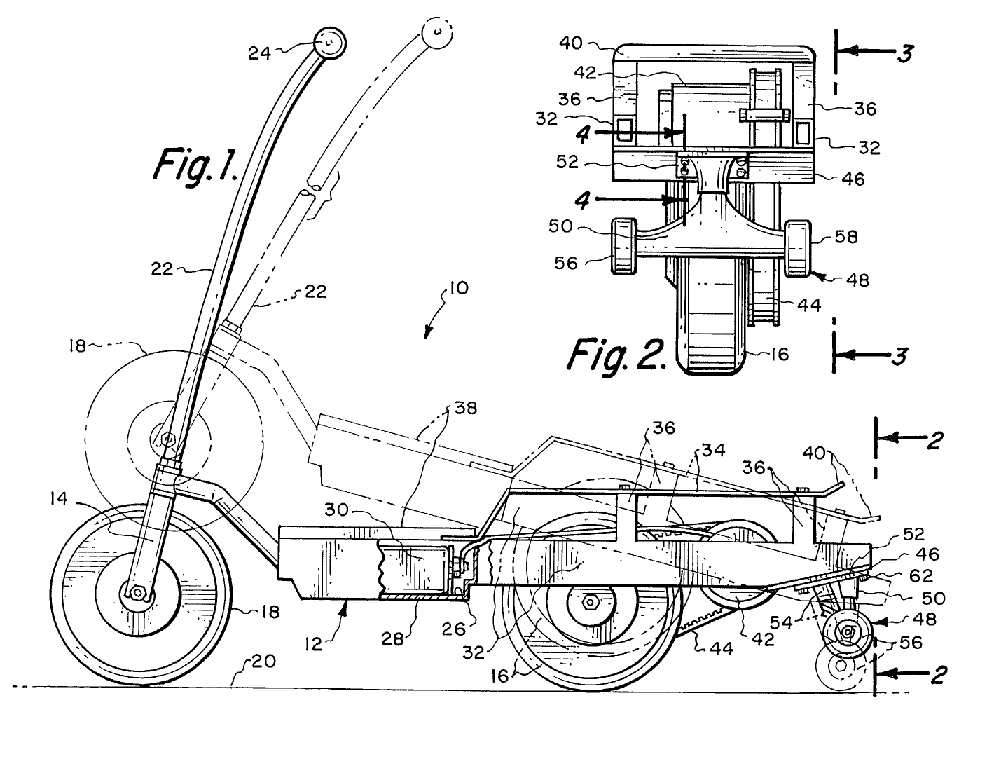

Formed within the mounting base 46 are four in number of elongated holes 60. Mounted on the mounting bracket 52 are four in number of bolt type fasteners 62. A fastener 62 is to connect with a single elongated hole 60. The longest dimension of the elongated holes 60 is arranged parallel to the longitudinal axis 64 of the scooter 10. By loosening of the fastener 62, the mounting bracket 52 can be moved on the mounting base 46 with the result that the wheels 56 and 58 can be moved closer to the surface 20 or further away from the surface 20. When a desired distance has been achieved, the fasteners 62 are to be tightened fixing in position the auxiliary wheel assembly 48 onto the scooter 10. It is to be understood that the closer the wheels 56 and 58 are to the surface 20, the easier it is and the less amount of skill is required in order to produce a wheelie. The wheelie is produced by the rider yanking in an upward direction on the handlebar 24 when the scooter 10 is being propelled by the motor 42. This will cause the front wheel 18 to be raised from the surface 20, as is shown in phantom lines in FIG. 1. This raising is to occur sufficiently until the wheels 56 and 58 come into contact with the surface 20. When the wheels 56 and 58 are mounted so that they are the maximum spaced distance from the surface 20, the maximum degree of inclination of the scooter 10 will be obtained in the performing of a wheelie. This will also be the maximum degree of difficulty for the rider. When performing a wheelie, the rider will brace his or her trailing foot against the upwardly flared edge 40 of the standing platform 34.

Generally, an inexperienced rider will locate the wheels 56 and 58 as close as possible to the surface 20. As the rider becomes more experienced, the mounting bracket 52 will be adjusted relative to the mounting base 46, and when the wheels 56 and 58 are located the furthest distance from the surface 20, that will constitute the highest experienced level for the rider.

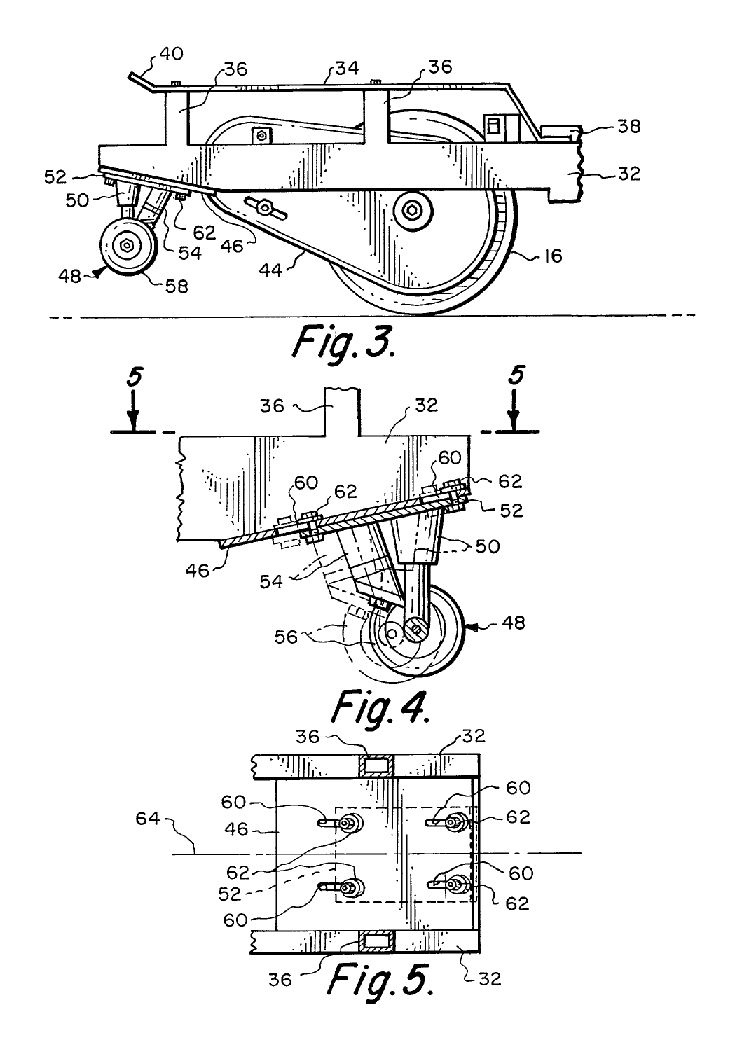

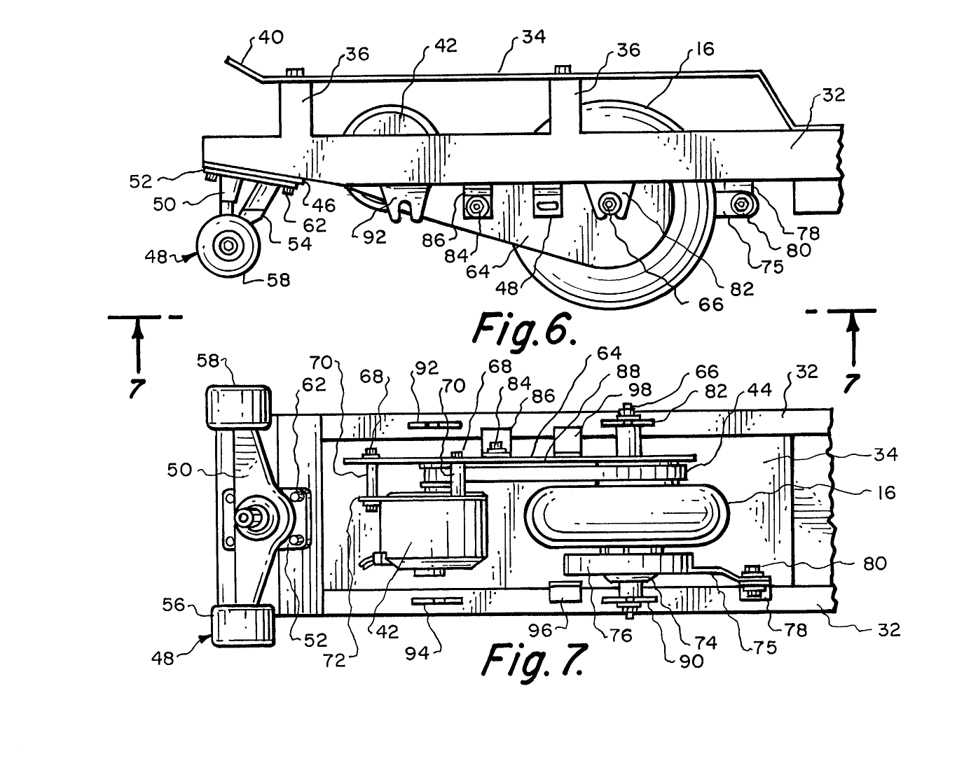

Referring particularly to FIGS. 6-9 of the drawings, there is shown a modified version of the present invention. This modified version relates to the inclusion of a mounting plate 64 which is not utilized within the basic embodiment of the present invention shown in FIGS. 1-5. However, for purposes of description, common structural parts between the modified version and the basic version of the present invention are denoted with the same reference numerals as were used to denote the same parts within FIGS. 1-5.

The rear wheel 16 is mounted on an axle 66. The axle 66 passes through a hole (not shown) formed within the mounting plate 64. Actually, the axle 66 is longitudinally fixed in position relative to the mounting plate 64 by structure which is not shown but where the axle 66 is still capable of being freely rotational relative to the mounting plate 64. The motor 42 is also fixedly mounted onto the mounting plate 64 by means of bolts 68. Each bolt 68 is mounted through a spacing sleeve 70 which functions to space the motor 42 a short distance away from the mounting plate 64. The bolts 68 are fixedly mounted onto motor bracket 72 which is fixedly mounted onto the casing of the motor 42.

The axle 66, after passing through the mounting plate 64 and the center of the rear wheel 16, then passes through a brake hub 74. The brake hub 74 is mounted within an enclosing ring 76. Enclosing ring 76 is integral with arm 75. The rider is to pull (or push) a lever (not shown) which acts through a cable (not shown) to cause the enclosing ring 76 to constrict against hub 74 causing the scooter to be slowed and eventually stop. Such a braking device is deemed to be conventional.

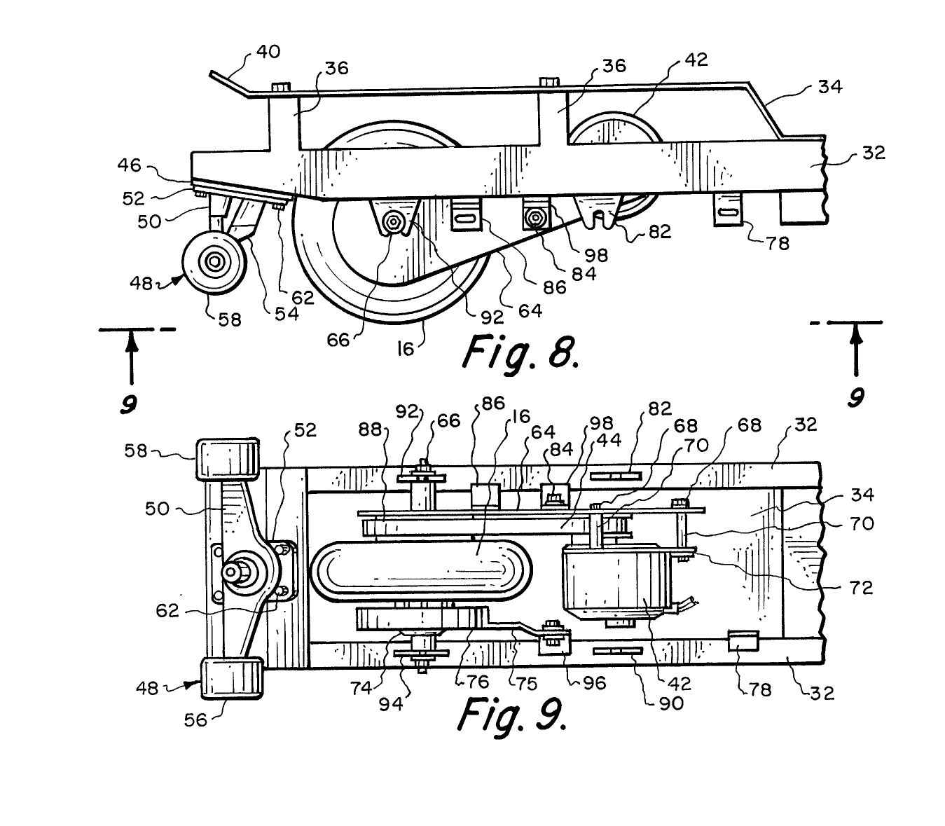

With the rear wheel 16 being located between the motor 42 and the front wheel 18, as is shown in FIG. 7, the mounting plate 64 is fixedly secured to an attachment 86 which is fixedly mounted onto the platform extension 32. A bolt 84 is mounted between the mounting plate 64 and the attachment 86. One end of axle 66 is rotationally mounted to attachment 90 which is fixed to platform extension 32. Arm 75 is fixed to attachment 78 by bolt 80. Attachment 78 is also fixed to platform extension 32. The opposite end of the axle 66 is fixedly mounted to an attachment 82 which is also fixedly mounted onto the platform extension 32. The attachments 78, 82 and 86 provide the mounting support for the rear wheel 16, motor 42 and mounting plate 64 to the platform extension 32 when in the first position of mounting, which is shown in FIGS. 6 and 7. Mounted on the inside surface of the mounting plate 64 is a belt pulley 88. Associated with the belt pulley 88 is the drive belt 44. The drive belt 44 is drivingly connected to an output pulley (not shown) of the motor 42 and a driven pulley (not shown) which is mounted in conjunction with the rear wheel 16. It is to be understood that the motor 42 is to receive electrical energy from a battery source, such as battery 30.

In the modified mounting arrangement of the rear wheel 16 shown in FIGS. 6 and 7, in essence, the configuration is essentially identical to what is shown in FIG. 1. The motor 42 is located between the auxiliary wheel assembly 48 and the rear wheel 16 which means that the rear wheel 16 is spaced some distance from the auxiliary wheel assembly 48 with this spacing being required in order to permit the user to use the scooter 10 in order to perform wheelies. Because the rear wheel 16 is spaced some distance from the auxiliary wheel assembly 48 and closer to the front wheel 18, the scooter 10 has a shortened wheelbase. This shortened wheelbase generally makes the scooter 10 more difficult to operate and probably will be operated by more experienced riders. If the scooter 10 is intended to be operated by a less experienced rider, and a rider that is not at the skill level to perform wheelies, the rider can transform the modified mounting arrangement of FIGS. 6 and 7 to the configuration shown in FIGS. 8 and 9 which will place the rear wheel 16 directly adjacent the auxiliary wheel assembly 48 and locate the motor 42 between the front wheel 18 and the rear wheel 16. This will extend the wheelbase of the scooter with this extended wheelbase making it easier to use the scooter 10. However, the scooter 10 will generally not be usable to perform wheelies and using of the auxiliary wheel assembly 48. The user could actually perform a wheelie, but the wheelie would be exceedingly difficult to perform when in the position shown in FIGS. 8 and 9.

To locate the modified mounting version in the position shown in FIGS. 8 and 9 from the position of FIGS. 6 and 7, the axle 66 is disengaged from attachment 82 and aligned attachment 90 which is also mounted on the platform extension 32. Attachment 90 is located on the side opposite the attachment 82 keeping in mind that the platform extension 32 is actually composed of a pair of bifurcated members with attachment 82 being mounted on one bifurcated member and attachment 90 being mounted on the opposite bifurcated member. The bolt 84 is also to be disengaged from the attachment 86. The rear wheel unit, which is composed of rear wheel 16, mounting plate 64 and motor 42, can now be turned one hundred eighty degrees with axle 66 now being mounted in conjunction with attachments 92 and 94 which are also mounted on the platform extension 32. The bolt 84, instead of connecting with attachment 86, now connects with attachment 98 which is also fixedly mounted on the platform extension 32. The bolt 84 is disengaged from the attachment 86 and then engaged with attachment 98. At the same time, the bolt 80 is disconnected from attachment 78 and then is reconnected with attachment 96. Basically, in comparing FIGS. 8 and 9 with respect to FIGS. 6 and 7, the left wheel 16 has assumed the position of the motor 42 and the motor 42 has assumed the position of the left wheel 16. The position in FIGS. 8 and 9, which will be referred to as the second position, permits the scooter 10 to be operated as a conventional scooter with a longer wheelbase.

The present invention may be embodied in other specific forms without departing from the essential attributes thereof. Reference should be made to the appending claims rather than the foregoing specification as indicating the scope of the invention.

What is claimed is:

1. A wheelie scooter comprising:
a main platform mounted between a front wheel and a rear wheel, said front wheel and said rear wheel to normally rest on a surface during normal movement of said wheelie scooter on the surface;
a steering post mounted to said front wheel;
a handlebar attached to said steering post;
a motor connected to said rear wheel;
a platform extension connected to said main platform and extending outwardly of said rear wheel;
a mounting base mounted on said platform extension, said mounting base being inclined relative to the surface; and
an auxiliary wheel assembly including a mounting bracket, said mounting bracket being fixedly mountable on said mounting base, said mounting bracket being adjustable to various positions with said auxiliary wheel assembly fixedly located in each of said positions, said auxiliary wheel assembly being located aft of said rear wheel, said auxiliary wheel assembly including an auxiliary wheel which is spaced from the surface when both said front wheel and said rear wheel are resting on the surface, whereby when a user performs a wheelie said front wheel becomes spaced from the surface with said rear wheel and said auxiliary wheel being in contact with the surface.

2. The wheelie scooter as defined in claim 1 wherein:
said motor comprising an electrically driven motor operated by a battery.

3. The wheelie scooter as defined in claim 1 wherein:
said mounting base having a flat surface, said mounting bracket being mounted on said flat surface.

4. The wheelie scooter as defined in claim 1 wherein:
said mounting bracket being adjustably mounted on the mounting base by a series of elongated slots with there being a separate fastener mounted within each of said elongated slots.

5. The wheelie scooter as defined in claim 1 wherein:
said auxiliary wheel being smaller than said rear wheel.

6. The wheelie scooter as defined in claim 1 wherein:
said mounting base having a forward edge and rearward edge, said forward edge being located closer to said rear wheel than said rearward edge, said forward edge being located closer to the surface than said rearward edge.

7. The wheelie scooter as defined in claim 1 wherein:
said rear wheel being adjustable between multiple positions and fixable to said main platform in each said position permitting said scooter to operate as a normal scooter in one said position and as a wheelie scooter in another said position.

8. A scooter comprising:
a platform extension mounted between a front wheel and a rear wheel, said front wheel and said rear wheel to normally rest on a surface during movement of said wheelie scooter on the surface; and
said rear wheel being adjustable between multiple positions to and fixable to said platform extension in each said position permitting said scooter to operate as a normal scooter in one said position and as a wheelie scooter in another said position.

9. A scooter comprising:
a platform extension mounted between a front wheel and a rear wheel, said front wheel and said rear wheel to normally rest on a surface during normal movement of said wheelie scooter on the surface;
a mounting plate, a motor mounted on said mounting plate, said rear wheel being mounted on a mounting plate, said mounting plate being mounted on said platform extension, said mounting plate being mountable in a first position and a second position on said platform extension with said first position locating said rear wheel between said motor and said front wheel and said second position locating said motor between said rear wheel and said front wheel, whereby said first position permits said scooter to be operable to perform wheelies and said second position permits said scooter to operate as a normal scooter generally not intending to perform wheelies.
